(19) United States
(12) Patent Application Publication
(10) Pub. No.: US 2005/0031959 A1
(43) Pub. Date: Feb. 10, 2005

(54) Positive electrode material mixture and alkaline battery using the same

(75) Inventors: Susumu Kato, Osaka (JP); Eiji Tano, Osaka (JP); Shinichi Sumiyama, Osaka (JP); Shuji Fujiwara, Hiroshima (JP); Yasushi Sumihiro, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/895,843

(22) Filed: Jul. 22, 2004

(30) Foreign Application Priority Data
Aug. 5, 2003 (JP) JP2003-287070

(51) Int. Cl. H01M 4/62; H01M 4/50; H01M 4/52

(52) U.S. Cl. 429/232; 429/223; 429/224

(57) ABSTRACT

In order to provide a positive electrode material mixture for an alkaline battery, the positive electrode material mixtures having small weight variations, a granulated mixture with favorable fluidity is used which comprises graphite and a positive electrode active material containing at least one of manganese dioxide and nickel oxyhydroxide, and has an angle of repose of 20 to 43 degrees.

### BACKGROUND OF THE INVENTION

The present invention relates to a positive electrode material mixture and an alkaline battery using the same.

With respect to a method for producing a material mixture for use in batteries, for example, Japanese Laid-Open Patent Publication No. Hei 10-81516 proposes a primary particle of silver oxide for filling a battery container of a silver oxide battery, with a mean particle size defined to 5 to 20 μm, a bulk density to 1.9 to 2.6 g/cm³ and an angle of repose to 25 degrees or less. Such definition enables production of a mixture of silver oxide having favorable fluidity and small filling variations.

On the other hand, in a cylindrical alkaline battery, a positive electrode material mixture is molded into hollow-cylindrical form. A mold for such molding has a hollow-cylindrical space with a depth about 10 times as large as a width. When a positive electrode active material particle as it is fills the mold, therefore, a void may be created in the space of the mold, easily resulting in weight variations of positive electrode material mixtures.

As a method for improving such filling variations, the specification of Japanese Patent No. 3192105 discloses a technique in which positive electrode active material particles and graphite particles as conductive agent are previously mixed, and a particle size of the obtained mixture is enlarged (granulated) to produce a granulated mixture, which is then molded into hollow-cylindrical form.

In the following explained is a method for producing a hollow-cylindrical positive electrode material mixture, shown in FIG. 2.

First, a mixture including manganese dioxide and graphite is press-molded with a roll press into plate form, which is then ground and sieved to obtain a granular granulated mixture.

On the other hand, a center pin is positioned at the center of a hollowing part of a hollow-cylindrical mold (dice), and a lower plunger is inserted into the space formed by the dice and the center pin. While the lower pestle is moved downward from a prescribed position, the space formed by the dice and the center pin is filled with the granulated mixture. After being slightly moved downward from the prescribed position, the lower pestle is moved up back to the prescribed position in order to make the space certainly filled with the granulated mixture. After the filling, the granulated mixture is arranged along with the upper face of the dice, using a pallet. Subsequently, the granulated mixture having filled the space is press-molded by pressing the granulated mixture from the above with an upper plunger, to obtain a hollow-cylindrical positive electrode material mixture.

Even in the case of using the aforesaid granulated mixture, however, it has been difficult to sufficiently eliminate weight variations of positive electrode material mixtures. Further, fluidity of a granulated mixture for use in alkaline batteries has not been specifically considered.

### BRIEF SUMMARY OF THE INVENTION

In order to solve the above conventional problems, it is an object of the present invention to provide a positive electrode material mixture for an alkaline battery with small weight variations by using a granulated mixture having favorable fluidity. It is also an object of the present invention to provide an alkaline battery having stable discharge capacity by using the positive electrode material mixture.

A positive electrode material mixture for an alkaline battery in accordance with the present invention includes a granulated mixture which comprises graphite and a positive electrode active material containing at least one of manganese dioxide and nickel oxyhydroxide, wherein the granulated mixture has an angle of repose of 20 to 43 degrees.

It is preferable that the angle of repose be from 20 to 38 degrees.

It is preferable that the granulated mixture contain 1 to 4 wt % of water.

It is preferable that the manganese dioxide and nickel oxyhydroxide have a median diameter of 25 to 45 μm.

It is preferable that the graphite have a median diameter of 8 to 20 μm.

It is preferable that 0.1 to 1 part by weight of a binder be included relative to 100 parts by weight of the granulated mixture.

It is preferable the particle thickness t₁ and the major particle axis t₂ of the granulated mixture satisfy the relational formula: 0.4<t₂/t₁<1.6.

It is preferable that the granulated mixture be obtained such that a mixture of graphite and one of manganese dioxide and nickel oxyhydroxide is transformed into a flake with a thickness t₁ and then ground and screened using a sieve with the largest opening t₂.

The present invention further relates to an alkaline battery using the aforesaid positive electrode material mixture.

According to the present invention, the use of a granulated mixture having favorable fluidity allows provision of a positive electrode material mixture for an alkaline battery, the positive electrode material mixtures having small weight variations. Moreover, the use of this positive electrode material mixture enables provision of an alkaline battery having stable discharge capacity.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical sectional view schematically showing an alkaline battery of the present invention.

FIG. 2 is a top plan view (1) and a vertical sectional view (2) showing a common positive electrode material mixture.

FIG. 3 is a structural view showing a method for measuring an angle of repose.

### DETAILED DESCRIPTION OF THE INVENTION

The present invention relates to a positive electrode material mixture for an alkaline battery, including a granulated mixture which comprises graphite and a positive electrode active material containing at least one of manganese dioxide and nickel oxyhydroxide, wherein the granulated mixture has an angle of repose of 20 to 43 degrees. It is to be noted that “granulation” in the present invention means increasing a particle size.

When the angle of repose of the granulated mixture exceeds 43 degrees, the filling property of the granulated mixture deteriorates to cause an increase in weight variations of the positive electrode material mixtures. When the angle of repose of the granulated mixture becomes below 20 degrees, the moldability of the granulated mixture deteriorates, thereby making it difficult to obtain a prescribed positive electrode material mixture by molding. It is particularly preferable that the angle of repose be from 20 to 38 degrees.

As for the graphite used can be expanded graphite, artificial graphite, natural graphite or the like, and a mixture of those graphite can also be used.

An amount of water contained in the granulated mixture is preferably from 1 to 4 wt %.

When the amount of water contained in the granulated mixture falls below 1 wt %, the angle of repose of the granulated mixture increases to result in larger weight variations of the positive electrode material mixtures. When the amount of water contained exceeds 4 wt %, the mold release property of the positive electrode material mixture deteriorates, thereby causing significant attrition of the mold. It is particularly preferable that the amount of water contained be from 2.5 to 4.0 wt %.

Median diameters of the manganese dioxide and nickel oxyhydroxide are preferably from 25 to 45 μm. When the median diameter is smaller than 25 μm, the angle of repose of the granulated mixture increases to cause larger weight variations of the positive electrode material mixtures. When the median diameter is larger than 45 μm, a specific surface area becomes smaller, leading to deterioration in discharge capacity. It is preferable that the median diameters of the manganese dioxide and nickel oxyhydroxide be from 25 to 30 μm.

A median diameter of the graphite is preferably from 8 to 20 μm. When the median diameter of the graphite is smaller than 8 μm, the angle of repose of the granulated mixture increases to cause larger weight variations of the positive electrode material mixtures. When the median diameter exceeds 20 μm, absorption of the electrolyte into the positive electrode material mixture becomes more difficult, and the amount of the electrolyte added thereto is thus reduced, causing a decrease in discharge capacity. It is more preferable that the median diameter of the graphite be from 8 to 12 μm.

An amount of a binder added to the positive electrode material mixture of the present invention is preferably from 0.1 to 1 part by weight, relative to the granulated mixture. When the binder is added in an amount of less than 0.1 wt %, the amount is so small that the effect of improving the angle of repose is not observed. When the binder is added in an amount of more than 1 wt %, the effect of suppressing the weight variations of the positive electrode material mixtures will not change while the positive electrode active material decreases by an amount equivalent to the amount of the binder added, thereby deteriorating the discharge capacity. It is particularly preferable that the amount of the binder added be from 0.1 to 0.5 wt %.

As the binder used can be polyethylene, polytetrafluoroethylene, polyvinylalcohol, sodium polyacrylate or the like.

The particle thickness t₁ and the major particle axis (length) t₂ of the granulated mixture preferably satisfy the relational formula: 0.4<t₂/t₁<1.6. Namely, the particle preferably has such a form as to satisfy this relational formula. Herein, the angle of repose of the granulated mixture is from 20 to 43 degrees, and thereby the weight variations of the positive electrode material mixtures are suppressed.

Further, the granulated mixture with the particle thickness t₁ and the major particle axis t₂, satisfying the relational formula: 0.4<t₂/t₁<1.6, can for example be obtained in the following manner.

Graphite is mixed with at least one of manganese dioxide and nickel oxyhydroxide to obtain a mixture. The mixture is transformed into a flake with a thickness t₁ by a roll press or the like, which is then ground and sieved using a sieve with the largest opening t₂. It is to be noted that the thickness t₁ of the flake and the opening t₂ of the sieve satisfy preferably the relational formula: 0.4<t₂/t₁<1.6. Further, the thickness t₁ of the flake can be considered as the thickness of a particle of the granulated mixture, which is obtained by grinding the flakes.

The present invention is specifically described below, using examples; however the present invention is not limited thereto.

### EXAMPLES

(i) Production of Positive Electrode Material Mixture

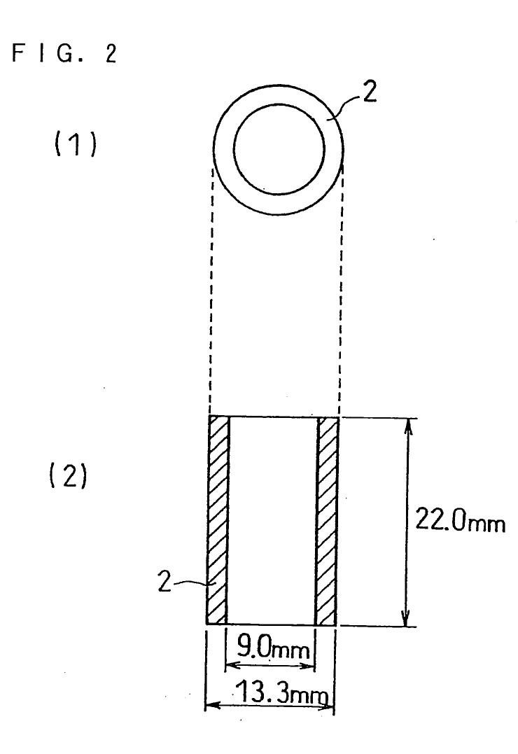

A manganese oxide powder with a median diameter of 35 μm and a graphite power with a median diameter of 15 μm were mixed in a weight ratio of 94:6 and then dry-stirred with a stirring mixer. Subsequently, the resultant mixture and 40 wt % of a potassium hydroxide aqueous solution were mixed in a weight ratio of 100:1, and then wet-stirred. This mixture was press-molded with a roll press into flake form. The flake-like mixture was ground with a granulator to obtain a granular granulated mixture. Herein, an amount of water in the granulated mixture was adjusted to 2.0 wt %. This granulated mixture was sieved using a sieve with 14 to 100 mesh. Thereafter, using a prescribed mold, a hollow-cylindrical space was filled with the obtained granulated mixture, which was then tableted to be molded into a hollow-cylindrical pellet with an external diameter of 13.3 mm, an internal diameter of 9.0 mm and a height of 22 mm, as shown in FIG. 2. A positive electrode material mixture was thereby obtained (EXAMPLE 1).

(ii) Production of Gel Negative Electrode.

Sodium polyacrylate as a gelling agent, 40 wt % of a potassium hydroxide aqueous solution as an alkaline electrolyte, and a zinc powder as a negative electrode active material were mixed in a weight ratio of 1:33:66 to obtain a gel negative electrode.

(iii) Assembly of Alkaline Battery

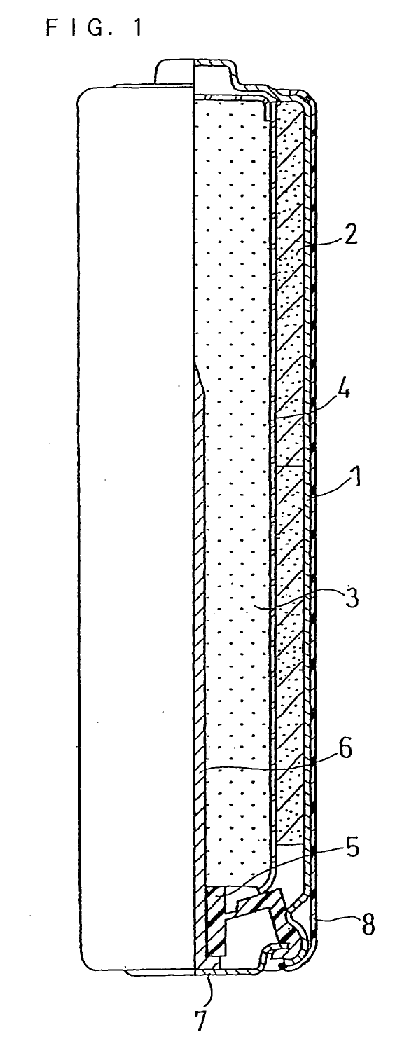

Using the positive electrode material mixture of EXAMPLE 1 and the gel negative electrode as obtained above, an alkaline battery having a structure shown in FIG. 1 was fabricated.

Two positive electrode material mixtures 2 obtained above were accomodated into a positive electrode case 1 and attached to the internal face of the positive electrode case 1. Herein, a steel case with the inner face thereof nickel-plated was used as the positive electrode case 1. A separator 4 comprising a polyvinyl alcohol fiber and a rayon fiber was disposed in the positive electrode material mixture 2, and then 40 wt % of a potassium hydroxide aqueous solution as the electrolyte was added therein. Thereafter, the inside of the separator 4 was filled with the gel negative electrode 3 obtained above. A negative electrode current collector 6 was integrated with a gasket 5, and a bottom plate 7 serving as a negative electrode terminal. The negative electrode current collector 6 was inserted into the center of the gel negative electrode 3. The open end of the positive electrode case 1 was caulked onto the periphery of the bottom plate 7 via the end of the gasket 5 so as to seal the opening of the positive electrode case 1. The outer face of the positive electrode case 1 was provided with an insulating exterior label 8 to fabricate an AA alkaline battery (LR6) (EXAMPLE 1).

The above-obtained granulated mixture, positive electrode material mixture and alkaline battery were estimated as follows:

[Evaluation]

(1) Measurement of Angle of Repose

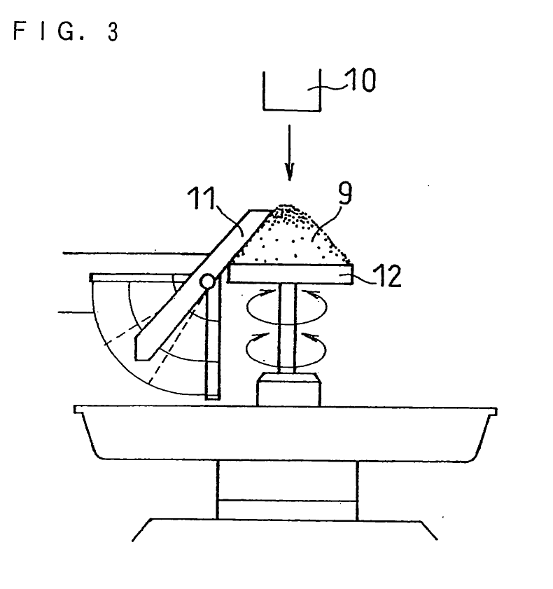

As shown in FIG. 3, the above-obtained granulated mixture 9 as a powder sample was dropped, through a funnel 10, from the position 15 cm higher than a prescribed round table 12 with 80 φ onto the surface of the round table 12. At this time, if necessary, a sieve with an opening of 1.18 mm (14 mesh) was installed and vibrated. The round table 12 was rotated, and then three angles among prescribed angles (angles of inclination of a conic powder sample, formed on the round table 12, versus the horizontal direction) were measured with a measuring device 11. The average of the measured three angles was referred to as an angle of repose (prescribed in JIS Z 2500 No. 1501). Generally, the less the angle of repose, the more favorable fluidity the granulated mixture has.

(2) Measurement of Variation Coefficient

100 of the aforesaid positive electrode material mixtures were produced and the weights of the respective positive electrode material mixture were measured. Based on the measurement results, a variation coefficient Cv was calculated by the formula:

Cv=(Standard deviation (σn−1)/average value (X)). The smaller the variation coefficient, the smaller the variations.

(3) Measurement of Discharge Capacity

The alkaline battery fabricated above was subjected to continuous discharge at a load of 10 Ω, and discharge capacity was measured. It should be noted that, at this time, a terminal voltage was 0.9 V.

Except that the amount of water contained in the granulated mixture was varied as shown in Table 1, positive electrode material mixtures were respectively obtained in the same manner as in EXAMPLE 1 (EXAMPLES 2 and 3, and COMPARATIVE EXAMPLE 1). Further, in the same manner as in EXAMPLE 1, the angle of repose of the granulated mixture and the variation coefficient of the weight of the positive electrode material mixture were determined.

The evaluation results of EXAMPLES 2 and 3, and COMPERATIVE EXAMPLE 1, are shown in Table 1, together with the evaluation results of EXAMPLE 1.

TABLE 1

| | | Angle of | |
|---|---|---|---|
| | Amount of | repose | Variation |
| | water (wt %) | (degree) | coefficient (Cv) |
| Comp. Ex. 1 | 0.5 | 44.8 | 2.23 |
| Ex. 2 | 1.0 | 42.2 | 1.46 |
| Ex. 1 | 2.0 | 37.0 | 1.08 |
| Ex. 3 | 4.0 | 34.8 | 0.96 |

The influence on the angle of repose by the amount of water contained in the granulated mixture was studied. As a result, in COMPARATIVE EXAMPLE 1 where the amount of water contained in the granulated mixture was less than 1 wt %, the angle of repose exceeded 43 degrees and the variation coefficient was large, leading to large weight variations of the positive electrode material mixtures. On the other hand, in EXAMPLES 1 to 3 where the amount of water contained was 1 to 4 wt %, the angle of repose was not more than 43 degrees and the variation coefficient was small, thereby suppressing the weight variations of the positive electrode material mixtures. It is to be noted that, when the amount of water contained in the granulated mixture exceeded 4.0 wt %, a mold release property deteriorates and production of the positive electrode material mixture then becomes difficult, resulting in significant attrition of the mold.

As shown in Table 2, except that a mixture of manganese dioxide and nickel oxyhydroxide (EXAMPLES 4 to 6), or nickel oxyhydroxide (EXAMPLE 7), was used as the positive electrode active material, the positive electrode material mixtures were obtained in the same manner as in EXAMPLE 1. The angle of repose of the granulated mixture and the variation coefficient of the weight of the positive electrode material mixture were determined in the same manner as in EXAMPLE 1. The evaluation results are shown in Table 2, together with the evaluation results of EXAMPLE 1.

TABLE 2

| | | Angle of | |
|---|---|---|---|
| | | repose | Variation |
| | *a | (degree) | coefficient (Cv) |
| Ex. 1 | 100:0 | 37.0 | 1.08 |
| Ex. 4 | 75:25 | 37.2 | 1.13 |
| Ex. 5 | 50:50 | 37.6 | 1.15 |
| Ex. 6 | 25:75 | 37.9 | 1.19 |
| Ex. 7 | 0:100 | 38.2 | 1.19 |

*a) Weight ratio of mixture of manganese dioxide to nickel oxyhydroxide

It was revealed from Table 2 that the angle of repose of the granulated mixture and the variation coefficient of the weight of the positive electrode material mixture were hardly affected by the change in weight ratio of the mixed materials constituting the positive electrode active material.

Except that the median diameter of graphite was varied as shown in Table 3, granulated mixtures were obtained in the same manner as in EXAMPLE 1 (EXAMPLES 8 to 10 and COMPARATIVE EXAMPLE 2). Except for the use of those granulated mixtures, positive electrode material mixtures were respectively obtained in the same manner as in EXAMPLE 1. Except for the use of those positive electrode material mixtures, alkaline batteries were fabricated in the same manner as in EXAMPLE 1. The granulated mixtures, positive electrode material mixtures and alkaline batteries, respectively obtained above, were evaluated in the same manner as in EXAMPLE 1.

The evaluation results were shown in Table 3, together with the evaluation results of EXAMPLE 1. It should be noted that, in Table 3, discharge capacities were shown as indexes versus the discharge capacity of EXAMPLE 1 which was considered as 100.

TABLE 3

| | Graphite | Angle of | Variation | |
|---|---|---|---|---|
| | median | repose | coefficient | Discharge |
| | diameter (μm) | (degree) | (Cv) | capacity |
| Comp. Ex. 2 | 5 | 45.9 | 2.22 | 102.5 |
| Ex. 8 | 8 | 42.1 | 1.54 | 101.9 |
| Ex. 1 | 15 | 37.2 | 1.08 | 100.0 |
| Ex. 9 | 20 | 36.9 | 1.03 | 99.0 |
| Ex. 10 | 25 | 36.8 | 0.99 | 96.1 |

As in EXAMPLES 1 and 8 to 10, when the angle of repose of the granulated mixture was not more than 43 degrees, the weight variations of the positive electrode material mixtures were suppressed. Above all, favorable discharge characteristics were obtained in the batteries of EXAMPLES 1, 8 and 9, using the positive electrode material mixtures which included graphite with a median diameter of 8 to 20 μm.

Except that the median diameter of manganese dioxide was varied as shown in Table 4, granulated mixtures were obtained in the same manner as in EXAMPLE 1 (EXAMPLES 11 to 13 and COMPARATIVE EXAMPLE 3). Except for the use of those granulated mixtures, positive electrode material mixtures were respectively obtained in the same manner as in EXAMPLE 1. Except for the use of those positive electrode material mixtures, alkaline batteries were fabricated in the same manner as in EXAMPLE 1. The granulated mixtures, positive electrode material mixtures and alkaline batteries, respectively obtained above, were evaluated in the same manner as in EXAMPLE 1.

The evaluation results were shown in Table 4, together with the evaluation results of EXAMPLE 1. It should be noted that, in Table 4, discharge capacities were shown as indexes versus the discharge capacity of EXAMPLE 1 which was considered as 100.

TABLE 4

| | | Angle of | Variation | |
|---|---|---|---|---|
| | | repose | coefficient | Discharge |
| | *b | (degree) | (Cv) | capacity |
| Comp. Ex. 3 | 20 | 45.0 | 1.97 | 102.6 |
| Ex. 11 | 25 | 41.5 | 1.47 | 101.3 |
| Ex. 1 | 35 | 37.2 | 1.08 | 100.0 |
| Ex. 12 | 45 | 36.8 | 1.04 | 98.7 |
| Ex. 13 | 55 | 36.5 | 1.05 | 96.4 |

*b) Manganese dioxide median diameter (μm)

As in EXAMPLES 1 and 11 to 13, when the angle of repose of the granulated mixture was not more than 43 degrees, the weight variations of the positive electrode material mixtures were suppressed. Above all, favorable discharge characteristics were obtained in the batteries of EXAMPLES 1, 11 and 12, using the positive electrode material mixtures which included manganese oxide with a median diameter of 25 to 45 μm.

Polyethylene as the binder was further added to the granulated mixture of EXAMPLE 3, as shown in Table 5. Except for the use of those granulated mixtures, positive electrode material mixtures were respectively obtained in the same manner as in EXAMPLE 3 (EXAMPLES 14 to 17). Except for the use of those positive electrode material mixtures, alkaline batteries were fabricated in the same manner as in EXAMPLE 3. The granulated mixtures, positive electrode material mixtures and alkaline batteries, respectively obtained above, were evaluated in the same manner as in EXAMPLE 3.

The evaluation results were shown in Table 5, together with the evaluation results of EXAMPLE 3. It should be noted that, in Table 5, discharge capacities were shown as indexes versus the discharge capacity of EXAMPLE 3 which was considered as 100.

TABLE 5

| | Amount of | Angle of | Variation | |
|---|---|---|---|---|
| | binder added | repose | coefficient | Discharge |
| | (wt %) | (degree) | (Cv) | capacity |
| Ex. 3 | 0.00 | 42.2 | 1.46 | 100.0 |
| Ex. 14 | 0.05 | 42.4 | 1.45 | 99.9 |
| Ex. 15 | 0.10 | 41.7 | 1.30 | 99.8 |
| Ex. 16 | 1.00 | 40.4 | 1.23 | 98.9 |
| Ex. 17 | 1.25 | 40.5 | 1.23 | 98.3 |

The larger the amount of the binder added, the more the angle or rest decreased. In EXAMPLE 14 where the amount of the binder added was below 0.1 wt %, the addition of the binder had a small effect. In EXAMPLE 17 where the added amount exceeded 1 wt %, the amount of the positive electrode active material decreased by an amount equivalent to the amount of the binder added, and therefore the discharge capacity decreased. Hence it was found that the preferable amount of the binder added was from 0.1 to 1 wt %.

Next studied were influences on the angle of repose as well as the variation coefficient when the ratio (t₂/t₁) of the particle thickness t₁ of the granulated mixture to the major particle axis t₂ of the granulated mixture was varied.

A granulated mixture with a particle thickness t₁ and a major particle axis t₂ was produced in the following manner.

A manganese oxide powder with a median diameter of 35 μm and a graphite power with a median diameter of 15 μm were mixed in a weight ratio of 94:6 and then dry-stirred with a stirring mixer. Subsequently, the resultant mixture and 40 wt % of a potassium hydroxide aqueous solution were mixed in a weight ratio of 100:1, and then wet-stirred. This mixture was press-molded with a roll press into flake form having a thickness t₁. The flake-like mixture was ground with a granulator to obtain a granular granulated mixture. Herein, an amount of water in the granulated mixture was adjusted to 2.0 wt %. This granulated mixture was screened using a sieve with the largest opening t₂. Subsequently, using a prescribed mold, a hollow-cylindrical space was filled with the obtained granulated mixture, which was then tableted so that a hollow-cylindrical pellet was molded to obtain a positive electrode material mixture (EXAMPLES 18 to 20, and COMPARATIVE EXAMPLES 4 and 5). Herein, the t₂/t₁ value was varied as shown in Table 6.

The granulated mixtures and positive electrode material mixtures, respectively obtained above, were evaluated in the same manner as in EXAMPLE 1. The evaluation results were shown in Table 6.

TABLE 6

| | | Angle of | |
|---|---|---|---|
| | | repose | Variation |
| | t₂/t₁ | (degree) | coefficient (Cv) |
| Comp. Ex. 4 | 1.70 | 45.3 | 1.77 |
| Ex. 18 | 1.51 | 41.9 | 1.49 |
| Ex. 19 | 1.05 | 37.0 | 1.10 |
| Ex. 20 | 0.45 | 42.6 | 1.50 |
| Comp. Ex. 5 | 0.37 | 44.7 | 1.88 |

It was found from Table 6 that, when the relational formula: 0.4<t₂/t₁<1.6, was satisfied, the angle of repose was not more than 43 degrees, and the weight variations of the positive electrode material mixtures were suppressed.

As thus described, the positive electrode material mixture of the present invention can be applied to an alkaline battery requiring small weight variations and stable discharge capacity, by the use of a granulated mixture having favorable fluidity.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A positive electrode material mixture for an alkaline battery, including a granulated mixture which comprises graphite and a positive electrode active material containing at least one of manganese dioxide and nickel oxyhydroxide, wherein
said granulated mixture has an angle of repose of 20 to 43 degrees.

2. The positive electrode material mixture for an alkaline battery in accordance with claim 1, wherein said angle of repose is from 20 to 38 degrees.

3. The positive electrode material mixture for an alkaline battery in accordance with claim 1, wherein said granulated mixture contains 1 to 4 wt % of water.

4. The positive electrode material mixture for an alkaline battery in accordance with claim 1, wherein said manganese dioxide and nickel oxyhydroxide have a median diameter of 25 to 45 μm.

5. The positive electrode material mixture for an alkaline battery in accordance with claim 1, wherein said graphite has a median diameter of 8 to 20 μm.

6. The positive electrode active material for an alkaline battery in accordance with claim 1, wherein 0.1 to 1 part by weight of a binder is included relative to 100 parts by weight of said granulated mixture.

7. The positive electrode material mixture for an alkaline battery in accordance with claim 1, satisfying the relational formula: 0.4<t₂/t₁<1.6 where t₁ is a particle thickness of said granulated mixture, and t₂ is a major particle axis of said granulated mixture.

8. The positive electrode material mixture for an alkaline battery in accordance with claim 7, wherein said granulated mixture is obtained such that a mixture of graphite and one of manganese dioxide and nickel oxyhydroxide is transformed into a flake with a thickness t₁, and then ground and screened using a sieve with the largest opening t₂.

9. An alkaline battery comprising the positive electrode material mixture in accordance with any of claims 1 to 8.
